(19) United States
(12) Patent Application Publication
(10) Pub. No.: US 2016/0124615 A1
(43) Pub. Date: May 5, 2016

(54) CAPTURING INTENT WHILE RECORDING MOMENT EXPERIENCES

(71) Applicant: Krumbs, Inc., Irvine, CA (US)

(72) Inventors: Neilesh JAIN, Irvine, CA (US); Ramesh JAIN, Irvine, CA (US); Pinaki SINHA, San Jose, CA (US)

(21) Appl. No.: 14/926,993

(22) Filed: Oct. 29, 2015

Related U.S. Application Data
(60) Provisional application No. 62/072,875, filed on Oct. 30, 2014.

(51) Int. Cl. G06F 3/0484; H04M 1/725; H04L 12/58; G06F 3/0482

(52) U.S. Cl. CPC G06F 3/04842; G06F 3/0482; H04M 1/72555; H04L 51/043

(57) ABSTRACT

A system for capturing intent while recording moment experiences is described. A system receives a notice to record moment data via a mobile device. The system outputs a pictogram set, from multiple pictogram sets, based on contextual information associated with the notice. The system receives a selection of a pictogram from the pictogram set. The system records the moment data. The system outputs the moment data with the selected pictogram.

### CLAIM OF PRIORITY

This application claims the benefit of U.S. Provisional Patent Application No. 62/072,875, filed Oct. 30, 2014, the entire contents of which are incorporated herein by reference.

### BACKGROUND

Users of mobile devices, such as smartphones, spontaneously share their experiences almost instantaneously via messaging platforms, emails, and social networks. Initially such sharing was done using text, such as “at Chargers' game,” “tasty food,” and “wish you were here.” Next sharing began to include still images, such as photographs, which mobile device users often annotated with text. Then sharing of experiences went beyond text and still images to include video recordings and/or audio recordings. A mobile device user may express a specific sentiment or intent with a recorded experience by first recording an experience (such as a photo or video), and then taking the time to supplement the recorded experience with text, a pictogram, and any additional information, such as by tagging people associated with the photo or video. Pictograms, including emojis, emoticons, ideograms, and icons, are often used as universally understood sentiment and intent conveying images. Mobile devices, including smartphones, may display selectable pictograms to provide easier ways for a user to quickly express sentiment and intent, which may be related to recorded experiences.

### BRIEF DESCRIPTION OF THE DRAWINGS

FIG. 1 illustrates a block diagram of an example system for capturing intent while recording moment experiences, under an embodiment;

FIGS. 2A and 2B are screen shots illustrating frames of example user interface screens of display devices supporting methods for capturing intent while recording moment experiences, under an embodiment;

FIG. 3 is a flowchart that illustrates a computer-implemented method for sharing moment experiences and pictograms, under an embodiment; and

FIG. 4 is a block diagram illustrating an example hardware device in which the subject matter may be implemented.

### DETAILED DESCRIPTION

Embodiments herein enable capturing intent while recording moment experiences. A notice is received to record moment data via a mobile device. A pictogram set is output, from multiple pictogram sets, based on contextual information associated with the notice. A selection is received of a pictogram from the pictogram set. The moment data is recorded. The moment data is output with the selected pictogram. A message can be added to the recorded moment data based on the selected pictogram and the contextual information.

For example, a smartphone's moment experience system receives a notice that the smartphone's user is activating the smartphone's digital camera application. The smartphone's moment experience system uses the smartphone's geographic location sensor and reverse geocoding information to identify the location of the smartphone in an exhibition hall at the University of California at Irvine, and uses the university's website and the smartphone's clock to identify that an art exhibit is scheduled in the exhibition hall at the time when the smartphone's user is activating the smartphone's digital camera application. Based on this contextual information which identifies the art exhibit, the smartphone's moment experience system outputs a pictogram set associated with curiosity, which includes pictograms that express happiness, disappointment, puzzlement, love, and notes.

The smartphone's moment experience system receives a selection of the happiness pictogram which is displayed by the smartphone's digital camera application, and this selection causes the smartphone's digital camera application to take a photo of a mask in the art exhibit. The smartphone's moment experience system receives the photo of the exhibited mask, and outputs the photo of the exhibited mask with the selected happiness pictogram. The smartphone's moment experience system can superimpose the message “Happy at University of California, Irvine (UCI), on Sun Sep. 20, 2015” on the photograph of the exhibited mask, which is based on the intent captured by the receipt of the selected happiness pictogram. The smartphone's user was able to express and effortlessly share the intent behind the experience, and did not have to spend any time searching through many unrelated pictograms to specify the user's sentiment or spend time writing a message for the recoded experience.

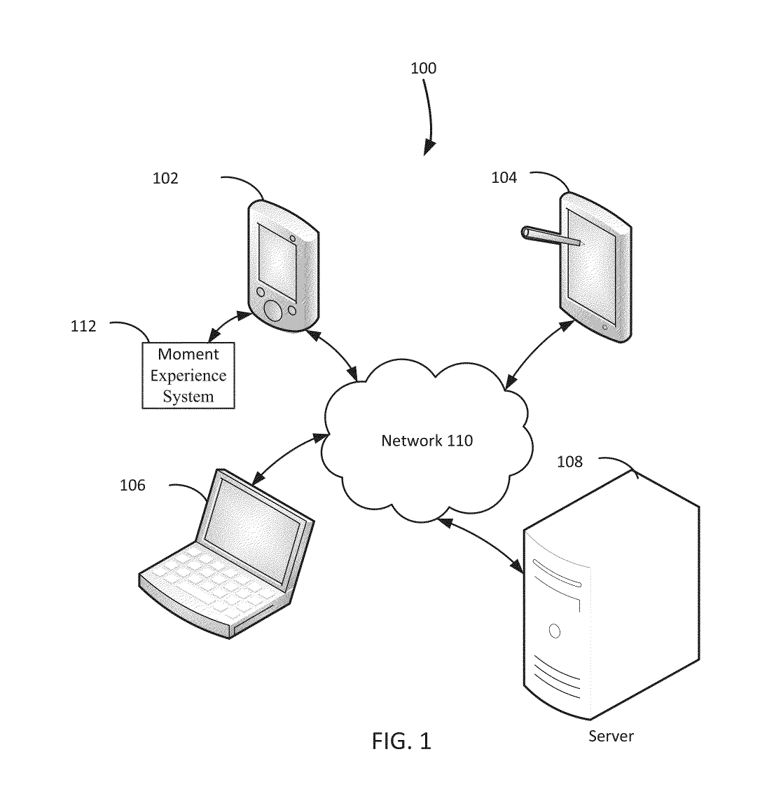

FIG. 1 illustrates a block diagram of an example system 100 for capturing intent while recording moment experiences, under an embodiment. As shown in FIG. 1, the system 100 may illustrate a cloud computing environment in which data, applications, services, and other resources are stored and delivered through shared data-centers and appear as a single point of access for the end users. The system 100 may also represent any other type of distributed computer network environment in which servers control the storage and distribution of resources and services for different client users.

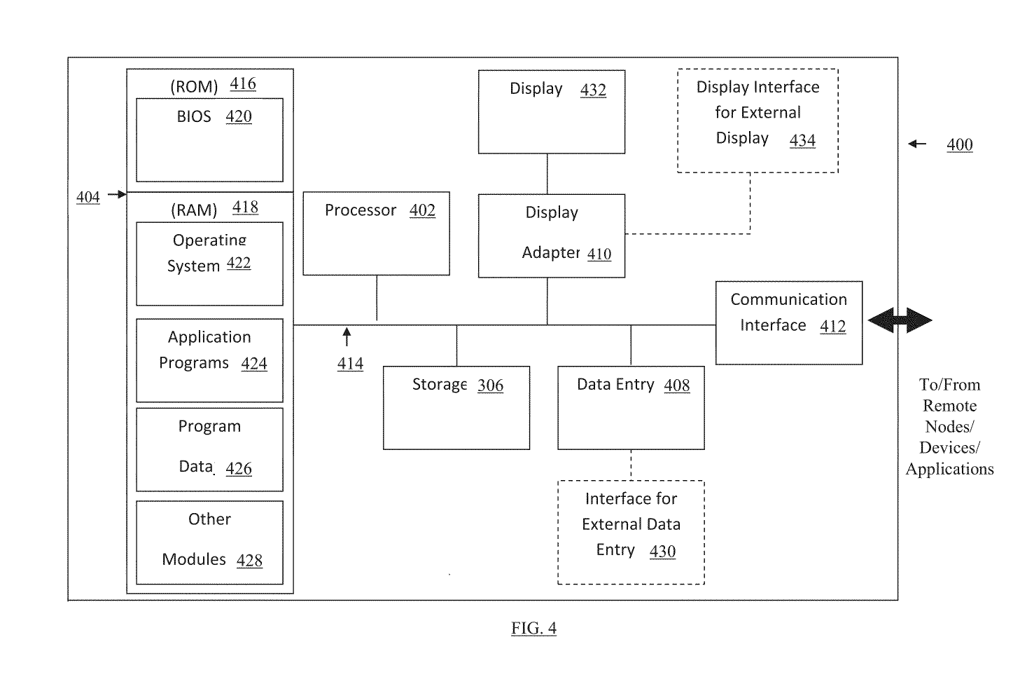

In an embodiment, the system 100 represents a cloud computing system that includes a first mobile device 102, a second mobile device 104, and a third mobile device 106; and a computer 108 that may be provided by a hosting company. The mobile devices 102-106 and the computer 108 communicate via a network 110. Although FIG. 1 depicts the system 100 with three mobile devices 102-106, one computer 108, and one network 110, the system 100 may include any number of mobile devices 102-106, any number of computers 108, and any number of networks 110. Further, although FIG. 1 depicts the first mobile device 102 as a smartphone 102, the second mobile device 104 as a tablet computer 104, the third mobile device 106 as a laptop computer 106, and the computer 108 as a server 108, each of the system components 102-108 may be any type of computer system. For example, any of the mobile devices 102-106 may be a mobile phone, a tablet computer, a laptop computer, a portable computer, a wearable computer, a dual mode handset, a dual subscriber identification module phone, a wireless mobile device, a pager, a personal digital assistant, a digital video player, a digital camera, a digital music player, a digital calculator, and/or an electronic key fob for keyless entry. The system elements 102-108 may each be substantially similar to the hardware device 400 depicted in FIG. 4 and described below. Although FIG. 1 depicts a moment experience system 112 residing on the smartphone 102, the moment experience system 112 may reside on any or all of the system elements 102-108.

Each of the mobile devices 102-106 may include a digital camera and an audio input to record moment data. The moment experience system 112 receives a notice to record moment data via a mobile device. For example, the moment experience system 112 receives a notice that the smartphone's user is activating the smartphone's digital camera application. Although this example describes moment data as a photo, the moment data may be any data captured at any moment(s) in time to record an experience of a mobile device user, such as a video recording, or an audio recording.

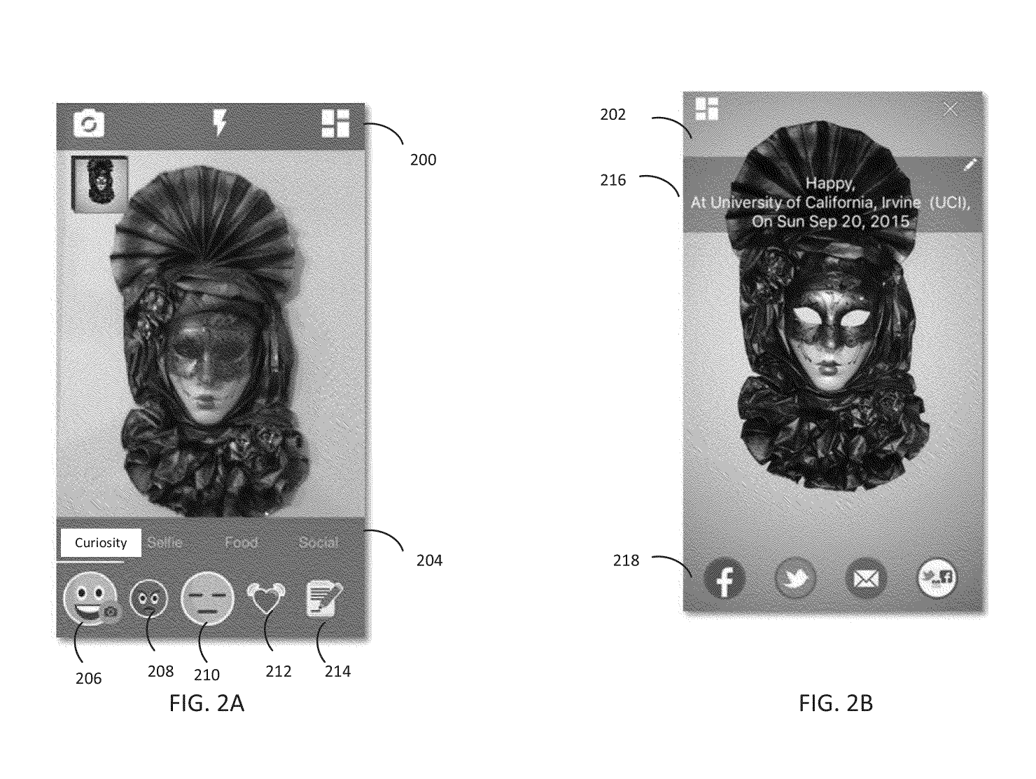

In response to receiving a notice to record moment data, the moment experience system 112 outputs a pictogram set, from multiple pictogram sets, based on contextual information associated with the notice. For example, the moment experience system 112 uses the smartphone's geographic location sensor and reverse geocoding information to identify the location of the smartphone 102 in an exhibition hall at the University of California at Irvine, and uses the university's web site and the smartphone's clock to identify that an art exhibit is scheduled in the exhibition hall at the time when the smartphone's user is activating the smartphone's digital camera application. Based on this contextual information which identifies the art exhibit, the smartphone's moment experience system 112 outputs a pictogram set 206-214 associated with curiosity, which includes a happiness pictogram 206, a disappointment pictogram 208, a puzzlement pictogram 210, a love pictogram 212, and a notes pictogram 214, as depicted by a frame 200 in FIG. 2.

Each of the mobile devices 102-106 may identify contextual information by using a geographic location sensor to identify geographic location information and a clock to identify time information. Each of the mobile devices 102-106 may also identify contextual information by using an accelerometer, an electronic gyroscope, a barometer, a galvanic skin response sensor, a heart rate monitor, a skin temperature sensor, a respiration rate sensor, a piezoelectric pulse wave blood pressure sensor, a skin conductivity sensor, a camera parameter sensor (exposure, focal length, f-number, ISO, etc), and/or a software application. The accelerometer may infer the activity of a mobile device user, such as sitting, standing, walking, running, driving, dancing, etc. The electronic gyroscope may measure the orientation and rotational movement of a mobile device user. The barometer may measure the elevation of a mobile device user above sea level. Physiological sensors, such as the heart rate monitor, the skin temperature sensor, the galvanic skin response (electrodermal activity) sensor, the respiration rate sensor, the piezoelectric pulse wave blood pressure sensor, and the skin conductivity sensor generate contextual information that may be used to infer the mental and physical state of a mobile device user. The moment experience system 112 may cache some of the contextual information, rather than querying contextual information every moment, thereby decreasing the latency, improving the throughput, and improving the battery life of the corresponding mobile device.

Such contextual information can determine which pictogram sets are displayed to the user so that the user may select from various types of emotions such as relaxed, surprised, happy, ecstatic, anger, stress, and sadness that may be associated with a moment. In another example, the moment experience system 112 receives contextual information identifying the date and time as 9:00 PM Saturday May 9^{th} from the clock residing on the smartphone 102, receives contextual information from the accelerometer residing on the smartphone 102 which indicates that the smartphone's user is dancing, and receives contextual information identifying a calendar entry for attending Jane's birthday party at 9:00 P.M. on May 9^{th} from the calendar application residing on the smartphone 102. Based on this contextual information which identifies dancing at a birthday party, the smartphone's moment experience system 112 outputs a pictogram set which includes pictograms related to dancing and birthday parties. Over time, the moment experience system 112 will understand a mobile device user's behaviors through analytics and output contextually personalized pictograms. In yet another example, the moment experience system 112 will output food-related pictograms when a smartphone use is at the user's favorite place to eat.

The moment experience system 112 may be able to select the best source of information when specific information is available from multiple sources, such as selecting the best reverse geocoding information from multiple sources of reverse geocoding information. A value may be derived from information sources that provide reverse geocoding information and the current conditions in which the moment data is to be captured, such as the weather at the current location, current traffic, an event occurring at a location, and the event's status. The moment experience system 112 can use the time combined with a geographic location to infer sunrise, sunset, full-moon, etc. The moment experience system 112 can use generic knowledge sources like ontologies to identify pictogram sets to be displayed for a mobile device user who is attending an event. The moment experience system 112 can use manually entered information, like the name of the venue, the schedule of an event (such as various sessions of a meeting or conference), and personal calendars of mobile device users to infer more information about moment data to be recorded. The moment experience system 112 can decrease the probable domain of all possible inferences associated with a moment to determine the most plausible inference.

The moment experience system 112 can use a set of rules to infer the experiences of a moment. In a further example, when a location ontology indicates that a mobile device user is in a wilderness area and the accelerometer and the heart rate sensor indicate that the mobile device user is walking, the moment experience system 112 can output a pictogram set which includes pictograms related to hiking. In an additional example, when a location ontology indicates that a mobile device user is at Joe's Bar & Grill, the clock indicates noon, and the accelerometer indicates that the mobile device user is sitting down, the moment experience system 112 can output a pictogram set which includes pictograms related to eating lunch. Some of the rules may be expressed as a set of if-else statements, which can be formulated using generic knowledge about human behavior or using domain specific knowledge. The set of rules may be a function which can map various types of information to a pictogram set, such as mapping the location, time, heart rate, weather sound, and various ontologies to a pictogram set.

For every moment that is to be recorded, the moment experience system 112 generates different inferences based on the different knowledge sources that contribute information for that moment. In an example, given latitude and longitude, the moment experience system 112 may infer different types of locations, such as restaurants, residential areas, outdoors and recreations, arts and entertainment centers, colleges and universities, travel and transportation, community event areas, and professional/offices. Examples of event ontologies include birthdays, graduations, weddings, anniversaries, religious events, and social events. Examples of activity ontologies include sitting, standing, walking, and running. Each of these ontologies may be stored in any type of data structure, including hierarchical data structures such as trees. For instance, the outdoor and recreation location type may have children types such as farms, campgrounds, national parks, forests, playgrounds, rivers, ski areas, etc. Similarly the scene category people may have children types such as selfies, groups, crowds, and babies. Therefore, the moment experience system 112 may access a set of knowledge trees instead of a set of flat level structures and combine multiple concept trees to select a pictogram set that is most likely to convey the sentiment of a moment experience.

Consequently, if the moment experience system 112 has access to K different knowledge sources (location, event, activity, etc.) with each knowledge source having N different values, then the total number of possible values is N×N×N . . . (K times)=NAK. Some of these possible values might be mutually incompatible, such as the possibility of someone hiking in a professional indoor area is very low. Therefore, the moment experience system 112 may consider all of the possible values to identify the optimal value. The moment experience system 112 may use automated algorithms to efficiently search through the NAK spaces to identify the optimal values for a current experience. The moment experience system 112 may also evaluate probabilistic values for each individual outcome. Some of these probabilistic values can come from rule based knowledge and other probabilistic values could come from machine learning based models.

If the smartphone user requests to select a pictogram that is not in the displayed set of pictograms, the moment experience system 112 receives the request to output another pictogram set from the multiple pictogram sets, and outputs another pictogram set. For example, the moment experience system 112 receives a request from the user of the smartphone 102 to output a different pictogram set because the user does not feel that any of the pictograms 206-214 express the user's current sentiment, and outputs a different pictogram set which includes different pictograms than the pictograms 206-214. The frame 200 indicates that the pictograms in the pictogram set 206-214 may be selected based on the curiosity mode, such that the smartphone user may select to display the pictograms in the social mode's pictogram set by selecting the social mode. Since a pictogram may be an ambiguous representation of a sentiment or an intent, each pictogram may be interpreted in many different ways. Therefore, each pictogram may be associated with multiple interpretations to make the interpretation less ambiguous and to provide more shades of intent/sentiment for a mobile device user to express. A mobile device user may select a more nuanced interpretation of a pictogram by sliding through the semantic equivalent linguistic interpretations that may suit the moment data better.

Having output a pictogram set, the moment experience system 112 receives a selection of a pictogram from the pictogram set and records the moment data. For example, the moment experience system 112 receives a selection of the happiness pictogram 206 which is displayed by the smartphone's digital camera application, and this selection causes the smartphone's digital camera application to take a photo of a mask in the art exhibit, thereby resulting in the moment experience system 112 receiving the photo of the exhibited mask. Through the receipt of the selected happiness pictogram, the moment experience system 112 automatically captures the intent of the user as happy when the user photographs the exhibited mask. By displaying the pictogram set instead of displaying a typical camera's photo-taking selection button, the moment experience system 112 forces the user to select the user's intent at the time when the user is taking a photo, without any additional manual interaction, thereby automatically capturing the user's intent. Broadly, there are five categories of information that may be recorded through moment data such as photos: Who (people), What (objects in the photo), When (time), Where (location) and Why (intent). The moment experience system 112 addresses the Why category by enabling a user to easily assign subjective intent to recorded moment data without too much manual interaction. Although this example describes the selection of a pictogram causing moment data to be recorded, in some embodiments the selection of the pictogram may occur before or after the activation of the mobile device to record moment data.

After receiving a selection of a pictogram which captures the user's intent, and recording moment data, the moment experience system 112 outputs the moment data with the selected pictogram. For example, the moment experience system 112 outputs the photo of the exhibited mask with the selected happiness pictogram. When the selected pictogram is output with the moment data, the selected pictogram may be displayed with the moment data and/or attached as metadata to the moment data, such that the selected pictogram may be used as metadata for searching for the moment data and/or creating a message for the moment data. The smartphone's user did not have to spend any time searching through many unrelated pictograms to specify the user's intent. When outputting moment data with a selected pictogram, the moment experience system 112 can output a message about the moment data based on the selected pictogram which captures the user's intent, and the context information. For example, the moment experience system 112 superimposes the message “Happy at University of California, Irvine (UCI), on Sun Sep. 20, 2015” 216 on the photograph of the exhibited mask, which is depicted in the frame 202 in FIG. 2. The moment experience system 112 can also combine multiple pictograms which are selected for the same moment data. For this example, selecting the combination of a pictogram for hiking and another pictogram for love can result in the moment experience system 112 superimposing the message “I love hiking” on a photo taken in a wilderness area, based on capturing two intents of the user. In both examples, the smartphone's user did not have to spend any time writing a message for the recoded experience.

When creating a message, the moment experience system 112 may infer multiple different inferences about an experience based on different information. For instance, the moment experience system 112 might infer that a mobile device user is walking in a wilderness area, on a windy day, during lunchtime when the mobile device user's selects a pictogram for amazement. The photo that the corresponding mobile device took at that moment depicts a deer. Rather than simply using the word “amazed” in the message, the moment experience system 112 attempts to create the best possible natural language description of the moment, such as the possible messages “Wow! Saw a deer while hiking at Coyote Creek Park,” “Surprised during lunchtime,” and so on. The moment experience system 112 can automatically identify the best message using algorithmic rules. The moment experience system 112 may also enable a mobile device user to choose from a few different message options, and learn from the user's choices when creating subsequent messages. Thus, the moment experience system 112 can automatically create the best possible description of the moment based on captured intent, with minimal user involvement.

The moment experience system 112 may rank individual knowledge sources. A photo of a group of people in a restaurant at 10 A.M. combined with a selected pictogram for enjoyment can result in a message such as “Delighted having breakfast with friends at XYZ restaurant,” or “Enjoying pancakes during breakfast,” or “Happy with friends on a sunny Sunday morning at Castro Street in San Francisco.” The moment experience system 112 may weigh the probability of each of these messages, and offer one or more of the messages to the user as selectable options. If the moment experience system 112 offers more than one message as an option, the user will be able to choose from these messages. The moment experience system 112 will be able to learn from past behavior of a user and better personalize the ranker. Thus, if a user has a preference for including family and friends in the past descriptive message, the moment experience system 112 will weigh people descriptions higher.

When the moment experience system 112 outputs the moment data with the selected pictogram, the moment experience system 112 may modify the moment data based on the selected pictogram. For example, if the smartphone user selected the happiness pictogram 206, then the moment experience system 112 uses image processing operations to modify the photo of the exhibited mask to appear brighter and more yellow-orange-ish, which is a brightness and temperature combination which people tend to associate with happiness. However, if the smartphone user selected the disappointed pictogram 208, then the moment experience system 112 uses image processing operations to modify the photo of the exhibited mask to appear darker and more blue-ish, which is a darkness and temperature combination which people tend to associate with disappointment. The information relevant to the moment data may be stored by any of the mobile devices 102-106, and may be referred to as “krumbs.”

The moment experience system 112 may output the moment data with the selected pictogram and automatically created message to a mobile device and/or a remote computer in communication with the mobile device. For example, the moment experience system 112 may output the photo and the automatically created message to the smartphone 102, so the smartphone's user can store the automatically created message with the photo in the smartphone's photo album, and to the other smartphones 104 and 106, via a messaging or chat platform through email of one or more social networks, such as a social network specifically created for sharing moment experiences.

At the recipient side, the moment data with the selected pictogram and automatically created message may be received with all associated “krumbs” using a specialized protocol using extension “krm.” The recipient's system interprets the “krm” format and renders the moment according to the settings used by the recipient. The rendering may consider a user's mobile device as well as his/her personal preferences for the media used when rendering the moment experienced.

After outputting moment data with a selected pictogram, the moment experience system 112 can create a user profile based on previously output moment data and selected pictograms. For example, the moment experience system 112 creates a user profile for the user who photographed the exhibited mask and selected the happiness pictogram 206, based on previous photos, videos, and audio recordings made by the user and previous pictograms selected by the user when recording the photos, videos, and audio recordings. The user profile and the associated moment data and selected pictograms may be stored locally on the smartphone 102, stored remotely on the server 108, or stored in any combination of locally and remotely.

Automated algorithms infer users' intents based on users' clicks on links to the text-oriented World Wide Web's webpages, the content of the user-selected webpages, and any other meta-information associated with the user-selected webpages, Since words in webpage text are defined in dictionaries, these algorithms translate a user's click to the semantics of words in a webpage; and from there, the intent of the user who clicked on the webpage is inferred. The visual and auditory world has no such semantic dictionary. Since user recorded data such as photos, videos, and audio recordings may have significantly more subjectivity than text documents when inferring intent, it is a much more difficult task to infer the intent from a user capturing photos, videos, and audio recordings. The moment experience system 112, however, captures intent and builds a profile using a user's clicks on pictograms, which record data in the visual and audio worlds. The moment experience system 112 makes these clicks more semantic by associating intent with the recorded data. In a way, the moment experience system 112 becomes a browser of a visual and audio web—the web which is built by users capturing photos, videos, and audio recordings using the moment experience system 112, and associating the intent behind a click of a pictogram with the “why” category from the who-what-when-where-why model. However, a user's dicks on pictograms are distinctly different from a user's clicks on links to the World Wide Web's webpages because the moment experience system 112 automatically associates intents from the user selected pictograms with the user recorded data.

After creating a user profile, the moment experience system 112 can output a message based on the user profile. For example, the moment experience system 112 outputs a message to the smartphone 102, suggesting that the user eat a healthy lunch at a restaurant where the user previously photographed lunches and selected healthy food pictograms, based on the user profile indicating a recent habit of the user to photograph lunches and select junk food pictograms. In another example, the moment experience system 112 outputs an advertisement to the smartphone 102, suggesting that the user eat a healthy lunch at a newly opened restaurant, based on the user profile indicating a recent habit of the user to photograph lunches and select junk food pictograms.

The moment experience system 112 may use a computer vision based object/scene detection system to identify content in the moment data, and then analyze the intent of the user as related to the identified content. For instance, a user may select a “boring” pictogram to create a first set of photos and select an “awesome” pictogram to create a second set of photos. The moment experience system 112 may use an object detection system might to identify urban building in the first set of photos and identify landscapes, vast open spaces, sunsets, and nature in the second set of photos. If the moment experience system 112 infers that the user prefers natural beauty more than urban areas, then the moment experience system 112 may suggest a visit to a place with natural beauty, rather than an urban area, when recommending a weekend trip. In another example, the moment experience system 112 uses facial detection and recognition software to identify Tim in a photo, or uses optical character recognition to read the nametag “Tim” in the photo to identify Tim in the photo because the facial recognition software was unable to identify beyond the required threshold level whether Tim was in the photo.

Similarly, the moment experience system 112 can use information from a geographic location sensor and reverse geocoding information to infer that the content identified in a photograph is an airport terminal, and not similarly appearing content for a bus station, subway station, or a train station. The moment experience system 112 can decrease the probable domain of all possible inferences associated with a moment to determine the most plausible inference. Similarly, given the pixels of an image captured, the moment experience system 112 may infer different types of scene categories, such as pets and animals, buildings, people, outdoors, indoors, food, and text/signs. Such correlation of captured intent can be performed with other types of information in addition to the content identified in moment data, such as a type of location or place.

A mobile device user may be able to use the moment experience system 112 without making any payment if the mobile device user agrees to allow the moment experience system 112 to use the user profile for advertising purposes. However, the mobile device user may have to pay for the use of the moment experience system 112 if the mobile device user does not permit the user profile to be used for advertising purposes. Additionally and/or alternatively, a mobile device user may select which moment data and accompanying pictograms are used for building the user profile and which moment data and accompanying pictograms are not used for building the user profile. For example, if a woman who eats only healthy food is recording each instance of when her husband eats junk food and selecting junk food pictograms as a way to persuade her husband to eat healthier food, then the woman may not want her own user profile to reflect all of the photos of junk food with the junk food pictograms.

FIG. 2A and FIG. 2B are screen shots illustrating frames 200 and 202 of example user interface screens of display devices for capturing intent while recording moment experiences in an embodiment. The frame 200 includes modes 204, which identifies different pictogram sets, such as curiosity, selfie, food and social. Although the modes 204 depicts only four modes, the moment experience system 112 may display any other types of modes, such as shopping or travel, and may display any number of modes, which may be selected from a significantly large number of available modes, each of which displays multiple associated pictograms.

A specific pictogram may be displayed by different modes, such as the bored pictogram being displayed in response to selection of either the social mode or the travel mode. Since the curiosity mode is highlighted, the displayed pictograms 206-214 are part of the curiosity mode's pictogram set. The displayed pictograms 206-214 include a happiness pictogram 206, a disappointment pictogram 208, a puzzlement pictogram 210, a love pictogram 212, and a notes pictogram 214. Each pictogram of the displayed pictograms 206-214 may also function as a photo/video/audio capture button on the smartphone 102. For example, a smartphone user selects the notes pictogram 214 when the smartphone user is taking notes at a meeting, which results in the smartphone 102 photographing information written on a whiteboard, which results in the moment experience system 112 creating the message “Taking notes, during meeting with Dr. Swanson, in Donald Bren Hall,” and superimposing this message over the photo of the whiteboard.

Although the frame 200 depicts five pictograms 206-214 as corresponding to the curiosity mode, each mode may have any number of corresponding pictograms. For example, when the selfie mode is selected, the frame 200 may display pictograms for admire, workout, party, arrived, and miss you. When the food mode is selected, the frame 200 may display healthy, junk, yum, drinking, and thumbs down. If the social mode is selected, the frame 200 may display pictograms for friends & family, surprised, bored, funny, and celebration. If a travel mode (not shown) is implemented and selected, the frame 200 may display pictograms for exploring, relaxing, natural beauty, bored, and awesome experience. Alternatively, additionally, if a shopping mode (not shown) is implemented and selected, the frame 200 may display pictograms for bargain, hold it, beautiful, buy, and irritated.

The frame 202 includes a message “Happy at University of California, Irvine (UCI), on Sun Sep. 20, 2015” 216 and sharing options 218, which enable sharing the moment data, the selected pictogram, and the message 216 via various types of communication when an option's corresponding icon is selected. In this example, the frame 202 displays the recorded moment data with the message 216 based on the selected happiness pictogram 206, but in some embodiments both the message 216 and the selected happiness pictogram 206 are displayed, while in other embodiments only the selected happiness pictogram 206 is displayed without the message 216 being displayed.

The frames 200-202 may be part of larger display screens that includes fields for users to enter commands to create, retrieve, edit, and store records. Because the frames 200-202 are samples, the frames 200-202 could vary greatly in appearance. For example, the relative sizes and positioning of the text is not important to the practice of the present disclosure. The frames 200-202 can be depicted by any visual displays, but are preferably depicted by computer screens. The frames 200-202 could also be output as reports and printed or saved in electronic formats, such as PDF. The frames 200-202 can be part of a personal computer system and/or a network, and operated from system data received by the network, and/or on the Internet. The frames 200-202 may be navigable by a user. Typically, a user can employ a touch screen input or a mouse input device to point-and-click to locations on the frames 200-202 to manage the text on the frames 200-202, such as a selection that enables a user to edit the text. Alternately, a user can employ directional indicators, or other input devices such as a keyboard. The text depicted by the frames 200-202 are examples, as the frames 200-202 may include much greater amounts of text. The frames 200-202 may also include fields in which a user can input textual information.

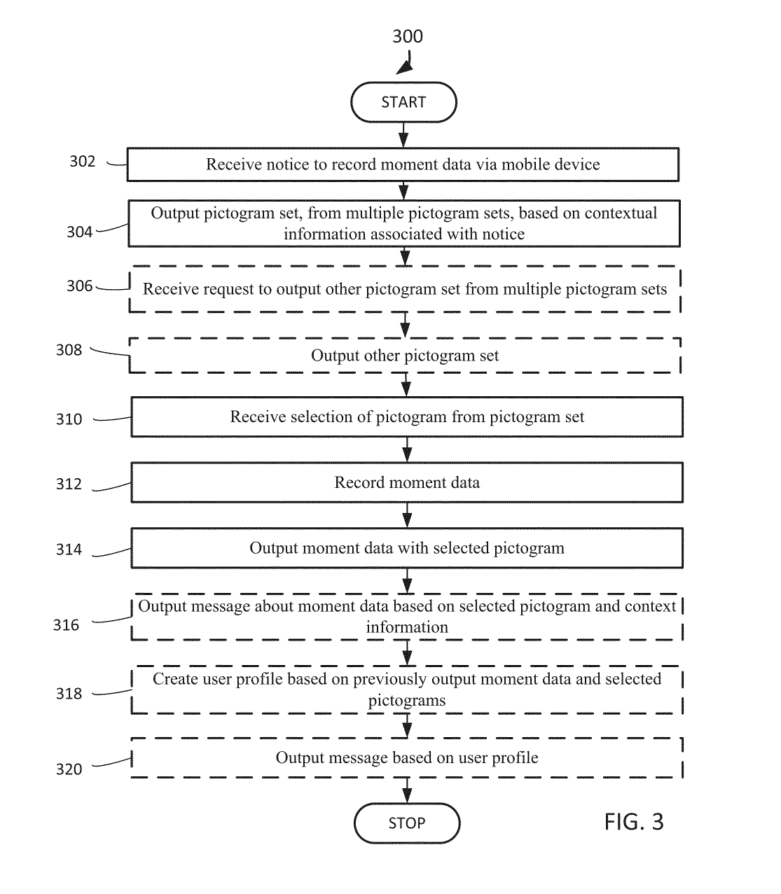

FIG. 3 is a flowchart that illustrates a computer-implemented method for sharing moment experiences and pictograms, under an embodiment. Flowchart 300 illustrates method acts illustrated as flowchart blocks for certain actions involved in and/or between the system elements 102-108 of FIG. 1.

The moment experience system 112 receives a notice to record moment data via a mobile device, block 302. For example and without limitation, this may include the moment experience system 112 receiving a notice that the smartphone's user is activating the smartphone's digital camera application.

In response to receiving a notice to record moment data, the moment experience system 112 outputs a pictogram set, from multiple pictogram sets, based on contextual information associated with the notice, block 304. By way of example and without limitation, this may include the moment experience system 112 using the smartphone's geographic location sensor and reverse geocoding information to identify the location of the smartphone 102 in an exhibition hall at the University of California at Irvine, and using the university's website and the smartphone's clock to identify that an art exhibit is scheduled in the exhibition hall at the time when the smartphone's user is activating the smartphone's digital camera application. Based on this contextual information which identifies the art exhibit, the smartphone's moment experience system 112 outputs a pictogram set 206-212 associated with curiosity, which includes a happiness pictogram 206, a disappointment pictogram 208, a puzzlement pictogram 210, a love pictogram 212, and a notes pictogram 214.

If the smartphone user requests to select a pictogram that is not in the displayed set of pictograms, the moment experience system 112 receives the request to output another pictogram set from the multiple pictogram sets, block 306. In embodiments, this may include the moment experience system 112 receiving a request from the user of the smartphone 102 to output a different pictogram set because the user does not feel that any of the pictograms 206-212 express the user's current sentiment.

If a request to output another pictogram set is received, the moment experience system 112 outputs another pictogram set, block 308. For example and without limitation, this may include the moment experience system 112 outputting a different pictogram set which includes different pictograms than the pictograms 206-212.

Having output a pictogram set, the moment experience system 112 receives a selection of a pictogram from the pictogram set, block 310. By way of example and without limitation, this may include the moment experience system 112 receiving a selection of the happiness pictogram 206 which is displayed by the smartphone's digital camera application, and this selection causes the smartphone's digital camera application to take a photo of a mask in the art exhibit.

After receiving a selection of a pictogram, the moment experience system 112 records moment data, block 312. In embodiments, this may include the moment experience system 112 receiving the photo of the exhibited mask.

After receiving a selection of a pictogram and recording moment data, the moment experience system 112 outputs the moment data with the selected pictogram, block 314. For example and without limitation, this may include the moment experience system 112 outputting the photo of the exhibited mask with the selected happiness pictogram.

When outputting moment data with a selected pictogram, the moment experience system 112 may output a message about the moment data based on the selected pictogram and context information, block 316. By way of example and without limitation, this may include the moment experience system 112 superimposing the message “Happy at University of California, Irvine (UCI), on Sun Sep. 20, 2015” 216 on the photograph of the exhibited mask.

After outputting moment data with a selected pictogram, the moment experience system 112 may create a user profile based on previously output moment data and selected pictograms, block 318. In embodiments, this may include the moment experience system 112 creating a user profile for the user who photographed the exhibited mask and selected the happiness pictogram 206, based on previous photos, videos, and audio recordings made by the user and previous pictograms selected by the user when recording the photos, videos, and audio recordings.

Once a user profile is created, the moment experience system 112 may output a message based on the user profile, block 320. For example and without limitation, this may include the moment experience system 112 outputting a message to the smartphone 102, suggesting that the user eat a healthy lunch at a restaurant where the user previously photographed lunches and selected healthy food pictograms, based on the user profile indicating a recent habit of the user to photograph lunches and select junk food pictograms.

Although FIG. 3 depicts the blocks 302-320 occurring in a specific order, the blocks 302-320 may occur in another order. In other implementations, each of the blocks 302-320 may also be executed in combination with other blocks and/or some blocks may be divided into a different set of blocks.

An exemplary hardware device in which the subject matter may be implemented shall be described. Those of ordinary skill in the art will appreciate that the elements illustrated in FIG. 4 may vary depending on the system implementation. With reference to FIG. 4, an exemplary system for implementing the subject matter disclosed herein includes a hardware device 400, including a processing unit 402, a memory 404, a storage 406, a data entry module 408, a display adapter 410, a communication interface 412, and a bus 414 that couples elements 404-412 to the processing unit 402.

The bus 414 may comprise any type of bus architecture. Examples include a memory bus, a peripheral bus, a local bus, etc. The processing unit 402 is an instruction execution machine, apparatus, or device and may comprise a microprocessor, a digital signal processor, a graphics processing unit, an application specific integrated circuit (ASIC), a field programmable gate array (FPGA), etc. The processing unit 402 may be configured to execute program instructions stored in the memory 404 and/or the storage 406 and/or received via the data entry module 408.

The memory 404 may include a read only memory (ROM) 416 and a random access memory (RAM) 418. The memory 404 may be configured to store program instructions and data during operation of the hardware device 400. In various embodiments, the memory 404 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. The memory 404 may also include nonvolatile memory technologies such as nonvolatile flash RAM (NVRAM) or ROM. In some embodiments, it is contemplated that the memory 404 may include a combination of technologies such as the foregoing, as well as other technologies not specifically mentioned. When the subject matter is implemented in a computer system, a basic input/output system (BIOS) 420, containing the basic routines that help to transfer information between elements within the computer system, such as during start-up, is stored in the ROM 416.

The storage 406 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 400.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which may store data that is accessible by a computer, such as magnetic cassettes, flash memory cards, digital video disks, Bernoulli cartridges, RAM, ROM, and the like may also be used in the exemplary operating environment. As used here, a “computer-readable medium” may include one or more of any suitable media for storing the executable instructions of a computer program in one or more of an electronic, magnetic, optical, and electromagnetic format, such that the instruction execution machine, system, apparatus, or device may read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 406, the ROM 416 or the RAM 418, including an operating system 422, one or more applications programs 424, program data 426, and other program modules 428. A user may enter commands and information into the hardware device 400 through data entry module 408. The data entry module 408 may include mechanisms such as a keyboard, a touch screen, a pointing device, etc. Other external input devices (not shown) are connected to the hardware device 400 via an external data entry interface 430. By way of example and not limitation, external input devices may include a microphone, joystick, game pad, satellite dish, scanner, or the like. In some embodiments, external input devices may include video or audio input devices such as a video camera, a still camera, etc. The data entry module 408 may be configured to receive input from one or more users of the hardware device 400 and to deliver such input to the processing unit 402 and/or the memory 404 via the bus 414.

A display 432 is also connected to the bus 414 via the display adapter 410. The display 432 may be configured to display output of the hardware device 400 to one or more users. In some embodiments, a given device such as a touch screen, for example, may function as both the data entry module 408 and the display 432. External display devices may also be connected to the bus 414 via the external display interface 434. Other peripheral output devices, not shown, such as speakers and printers, may be connected to the hardware device 400.

The hardware device 400 may operate in a networked environment using logical connections to one or more remote nodes (not shown) via the communication interface 412. The remote node may be another computer, a server, a router, a peer device or other common network node, and typically includes many or all of the elements described above relative to the hardware device 400. The communication interface 412 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 412 may include logic configured to support direct memory access (DMA) transfers between the memory 404 and other devices.

In a networked environment, program modules depicted relative to the hardware device 400, or portions thereof, may be stored in a remote storage device, such as, for example, on a server. It will be appreciated that other hardware and/or software to establish a communications link between the hardware device 400 and other devices may be used.

It should be understood that the arrangement of the hardware device 400 illustrated in FIG. 4 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 400.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 4.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter may also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for capturing intent while recording moment experiences, the system comprising:
one or more processors; and
a non-transitory computer readable medium storing a plurality of instructions, which when executed, cause the one or more processors to:
receive a notice to record moment data via a mobile device;
output a pictogram set, from a plurality of pictogram sets, based on contextual information associated with the notice;
receive a selection of a pictogram from the pictogram set;
record the moment data; and
output the moment data with the selected pictogram.

2. The system of claim 1, wherein the contextual information comprises at least one of geographic location information and time information, and wherein the moment data is recorded via at least one of a digital camera and an audio input.

3. The system of claim 1, wherein the plurality of instructions, when executed, will further cause the one or more processors to:
receive a request to output an other pictogram set, from the plurality of pictogram sets; and
output the other pictogram set; wherein receiving the selection of the pictogram from the pictogram set comprises receiving the selection of the pictogram from the other pictogram set.

4. The system of claim 1, wherein receiving the selection of the pictogram from the pictogram set comprises receiving the selection of the pictogram from a plurality of associated pictograms based on a plurality of interpretations corresponding to the plurality of associated pictograms.

5. The system of claim 1, wherein outputting the moment data with the selected pictogram comprises modifying the moment data based on the selected pictogram.

6. The system of claim 1, wherein the plurality of instructions, when executed, will further cause the one or more processors to output a message about the moment data based on the selected pictogram and the context information.

7. The system of claim 1, wherein the plurality of instructions, when executed, will further cause the one or more processors to:
create a user profile based on previously output moment data and selected pictograms; and
output a message based on the user profile.

8. A computer-implemented method for capturing intent while recording moment experiences, the method comprising:
receiving a notice to record moment data via a mobile device;
outputting a pictogram set, from a plurality of pictogram sets, based on contextual information associated with the notice;
receiving a selection of a pictogram from the pictogram set;
recording the moment data; and
outputting the moment data with the selected pictogram.

9. The computer-implemented method of claim 8, wherein the contextual information comprises at least one of geographic location information and time information, and wherein the moment data is recorded via at least one of a digital camera and an audio input.

10. The computer-implemented method of claim 8, wherein the method further comprises
receiving a request to output an other pictogram set, from the plurality of pictogram sets; and
outputting the other pictogram set; wherein receiving the selection of the pictogram from the pictogram set comprises receiving the selection of the pictogram from the other pictogram set.

11. The computer-implemented method of claim 8, wherein receiving the selection of the pictogram from the pictogram set comprises receiving the selection of the pictogram from a plurality of associated pictograms based on a plurality of interpretations corresponding to the plurality of associated pictograms.

12. The computer-implemented method of claim 8, wherein outputting the moment data with the selected pictogram comprises modifying the moment data based on the selected pictogram.

13. The computer-implemented method of claim 8, wherein the method further comprises outputting a message about the moment data based on the selected pictogram and the context information.

14. The computer-implemented method of claim 8, wherein the method further comprises
creating a user profile based on previously output moment data and selected pictograms; and
outputting a message based on the user profile.

15. A computer program product, comprising a non-transitory computer-readable medium having a computer-readable program code embodied therein to be executed by one or more processors, the program code including instructions to:
receive a notice to record moment data via a mobile device;
output a pictogram set, from a plurality of pictogram sets, based on contextual information associated with the notice;
receive a selection of a pictogram from the pictogram set;
record the moment data; and
output the moment data with the selected pictogram.

16. The computer program product of claim 15, wherein the contextual information comprises at least one of geographic location information and time information, and wherein the moment data is recorded via at least one of a digital camera and an audio input.

17. The computer program product of claim 15, wherein the program code includes further instructions to:
receive a request to output an other pictogram set, from the plurality of pictogram sets; and
output the other pictogram set; wherein receiving the selection of the pictogram from the pictogram set comprises receiving the selection of the pictogram from the other pictogram set.

18. The computer program product of claim 15, wherein receiving the selection of the pictogram from the pictogram set comprises receiving the selection of the pictogram from a plurality of associated pictograms based on a plurality of interpretations corresponding to the plurality of associated pictograms.

19. The computer program product of claim 15, wherein outputting the moment data with the selected pictogram comprises modifying the moment data based on the selected pictogram.

20. The computer program product of claim 15, wherein the program code includes further instructions to:
output a message about the moment data based on the selected pictogram and the context information;
create a user profile based on previously output moment data and selected pictograms; and
output a message based on the user profile.
